(19) United States
(12) Patent Application Publication
(10) Pub. No.: US 2007/0136080 A1
(43) Pub. Date: Jun. 14, 2007

(54) Garment registry

(76) Inventor: Andrew C. Jones, Stuart, FL (US)

Correspondence Address: AKERMAN SENTERFITT, P.O. BOX 3188, WEST PALM BEACH, FL, 33402-3188, US

(21) Appl. No.: 11/299,988

(22) Filed: Dec. 12, 2005

(51) Int. Cl. G06Q 99/00

(52) U.S. Cl. 705/1; 705/5

(57) ABSTRACT

A garment registration system enabling garments, such as dresses, to be registered with an event attendee to reduce the likelihood of two or more event attendees wearing an identical dress to the same event. The garment registration system may be available for viewing over the Internet or other appropriate communication system. The garment registration system may include a garment registration module configured to enable a garment to be registered in connection with an event and an event attendee. The garment registration system may also include a garment search module enabling an event attendee or other person to search the garment registration module to determine whether another event attendee is planning to wear a same garment to the event. The garment registration system may also include an event registration module that enables events to be registered to the system and an event search module enabling registered events to be searched.

### FIELD OF THE INVENTION

This invention relates to registration systems, and more particularly, to garment registrations systems.

### BACKGROUND OF THE INVENTION

Approximately 1,000,000 people attend formal events in the United States of America each year. Typically, attendance at a formal event entails the attendee purchasing, borrowing, or leasing a garment, such as a dress, for the event. Many event attendees, especially women, are very concerned with the social impact of their garment at the event. These event attendees are often extremely uncomfortable with the possibility of encountering someone else at the event wearing the exact same garment. To some people, such an encounter can ruin the entire experience at the event. Thus, a need exists for a system of reducing the likelihood of two or more event attendees wearing the same garment to the same event.

### SUMMARY OF THE INVENTION

This invention is directed to a garment registration system useful to assist event attendees in choosing garments. In one embodiment, the garment registration system may be useful for women to determine whether another woman will be wearing the same dress to the same event to prevent a potentially embarrassing situation from occurring at the event in which both women have on the same dress. The garment registration system may include numerous modules for facilitating registration of users, garments, and events and facilitating searching of garments and events. The garment registration system may be implemented using the Internet such that users may access the garment registration system at any Internet interface, such as, but not limited to, a personal computer, a mobile phone, and a handheld wireless Internet interface or other appropriate device.

The garment registration system may include a garment registration module configured to enable a garment to be registered in connection with an event and an event attendee. The garment registration system may also include an event registration module that enables events to be registered to the system. Events may include, but are not limited to, a community ball, such as but not limited to, a junior league ball, an inaugural ball, and a philanthropic ball, a political findraiser, a high school homecoming dance, a high school prom, a college greek function, a quinceanera party, a sweet sixteen party, and a new year's eve party.

The garment registration system may also include an event search module enabling registered events to be searched. The event search module may enable registered events to be searched by event location, event size, event date, event year, event name, type of event, event organizer, event entertainment, and other identifiers. Users of the garment registration system may register with a user registration module of the garment registration system. The garment registration system may also include a garment search module enabling a garment to be searched within the system. The garment search module may enable a garment to searched by the type of garment, the style of the garment, the maker of the garment, event, and other identifiers. The garment registration system may also include an event message module enabling messages to be posted for viewing. The event message module may include message boards for garments, types of events, event locations, and other appropriate groupings. The garment registration system may also include an advertising module configured to enable advertisements to be viewed concurrently with display screens of the garment registration system.

An advantage of this invention is that an event attendee may determine whether another attendee will be wearing a same dress to an event and avoid a potentially embarrassing situation of both attendees wearing the same dress to the event.

Another advantage of this invention is that an event attendee that uses the garment registration system may quell the anxiety of not knowing whether another attendee plans to wear the same dress to an event, thereby eliminating undue anxiety on the event attendee.

Yet another advantage of this invention is that advertisers are provided with an avenue of displaying advertisements to users within categories selected by the advertisers thereby increasing the efficiency of the advertisement.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a schematic diagram of components of the garment registration system.

FIG. 2 is a schematic diagram of manner of using the garment registration system.

### DETAILED DESCRIPTION OF THE INVENTION

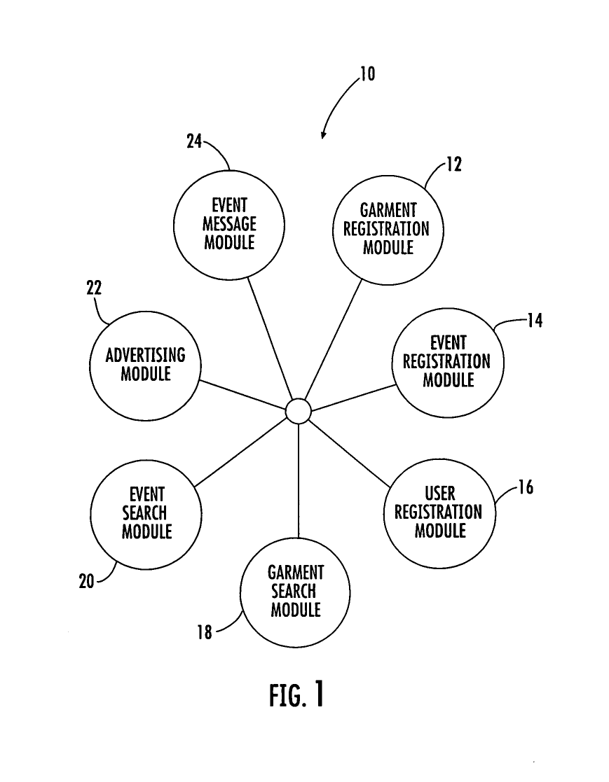

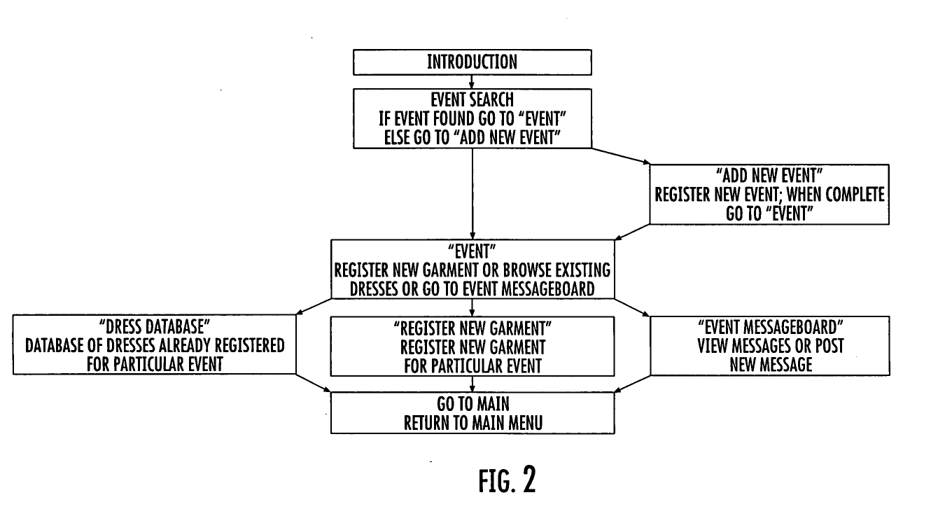

As shown in FIGS. 1-2, this invention is directed to a garment registration system 10 useful to assist event attendees in choosing garments. In one embodiment, the garment registration system 10 may be useful for women to determine whether another woman will be wearing the same dress to the same event to prevent a potentially embarrassing situation from occurring at the event. The garment registration system 10 may include numerous modules for facilitating registration of users, garments, and events and facilitating searching of garments and events. The garment registration system 10 may be implemented using the Internet such that users may access the garment registration system 10 at any Internet interface, such as, but not limited to, a personal computer, a mobile phone, a handheld wireless Internet interface. The garment registration system 10 may also be implemented using a closed circuit system or other appropriate device. The closed circuit system may exist within a single retail outlet, across a plurality of retail outlets, or within other locations.

As show in FIG. 1, the garment registration system 10 may include a garment registration module 12 configured to enable a garment to be registered in connection with an event and an event attendee. The event attendee may be any person attending an event, such as, but not limited to, a woman, man, girl or boy. The garment may be a dress, headgear, costume, or other garment desired to be registered. The garment registration module 12 may enable a user, or other person, to register a garment by providing any of the following information in appropriately titled data entry cells: garment type, name of garment maker, garment style, color, length, material, neckline, a description of the garment, and a UPC. For instance, a user may describe a garment being registered as a “dress having a neck area with pearls”. Before a garment is registered, a user can toggle through garments already registered for a particular event. If the same garment is found, the user may choose not to register the garment and continue shopping or return a garment that was bought. The garment registration module 12 may associate garments with events at which the garments are to be worn and may store garment registrations alphabetically by garment designer for each event. The garment registration module 12 may also store garment registrations in other appropriate manners.

The garment registration module 12 may also include an event registration module 14 that enables events to be registered to the system 10. The events may be registered by registered users of the system 10 or other appropriate people. Events that may be registered to the garment registration module 12 may include, but are not limited to, a community ball, such as but not limited to, a junior league ball, an inaugural ball, and a philanthropic ball, a political fundraiser, a high school homecoming dance, a high school prom, a college greek function, a quinceanera party, a sweet sixteen party, a new year's eve party, and other events. Details that may be registered in connection with an event include, location of a hosting facility, town, state, and country, zip code, time of event, and event contact information. Additional description of the event may be recorded if necessary or desired.

The garment registration system 10 may also include a user registration module 16 enabling a person to register with the garment registration system 10. The user registration module 16 may enable a user to establish a user name and password used to access the system 10. A user may also be queried during the registration process to enter a user's full name, home address, employer, occupation, income, marital status, alma mater, highest level of education, and other relevant personal information. In at least one embodiment, a user may be prompted by the user registration module 16 to submit payment of a fee to use the system 10. The systems 10 may require a registration fee such as a pay as you go system that bills a user by transaction, an annual fee, or other type of payment. Thus, the registration fee may generate income for the garment registration system 10.

The garment registration system 10 may also include a garment search module 18 enabling garments to be searched. Garments may be searched using the garment registration system 10 in numerous manners, such as, but not limited to, searching by garment designer name, garment style, garment type, color, length, material, neckline, a description of the garment, a UPC, and other appropriate search parameters.

The garment registration system 10 may also include an event search module 20 enabling events to be searched. The event search module 20 may work in cooperation with the garment search module 18 to enable an event to be located. An event may be searched in the system 10 using an event name, event type, event location, including, but not limited to, host facility, political identifiers, such as, but not limited to, city, county, state, country, zip code, or any combination thereof. The event search module 20 may be configured to display a screen having numerous data entry locations corresponding with the various manners that may be used to search the event search module 20.

The garment registration system 10 may also include an advertising module 22 configured to display one or more advertisements on a screen concurrently with a screen in the garment registration system 10 or at other appropriate times. The advertising module 22 may store advertisements or access advertisements stored in other locations. The advertising module 22 may also be configured to enable advertisers to determine target groups to which their advertisements will be displayed. For instance, an advertiser may desire for their advertisement to be viewed by girls under the age of 21 or users having an annual income of greater than 100,000 dollars. The advertising module 22 may be configured such that when a user logs into the system 10, the advertising module 22 may compare the personal information of the user to the records of the advertising module 22 and display advertisements on a screen that correspond with the personal information of the user. The advertising module 22 may be a source of income for the garment registration system 10. The advertising module 22 may include links to other sites to purchase items such as, but not limited to, dresses, shoes, tuxedos, cufflinks, bowties, cummerbunds, jewelry, hairclips, beauty salons, spas, limousines, wine, restaurants, hotels, magazines, and other appropriate items to be sold through the garment registration system 10.

The garment registration system 10 may also include an event message module 24 enabling users to post messages to the system 10. The event message module 24 may be configured such that messages may be posted for a particular event, type of event, location of event, or other such designation. The event message module 24 may enable users to post and read comments in relation to a particular event. The event message module 24 may also permit users to look at content in articles of interest and to link to other related websites or websites of advertisers.

The garment registration system 10 may be used in a variety of manners. For instance, a retail store may include a kiosk that enables a customer to login to the system 10 to determine if any of the garments that the customer is considering to purchase for an event has already been registered by another attendee of the event. Alternatively, the system 10 may be accessed through a personal computer, such as a desktop or laptop personal computer, or a wireless device, such as a handheld personal digital assistant (PDA), or other appropriate device. Such access enables users to make an informed decision before purchasing a garment.

When a user first accesses the system 10, the user may be asked to log into the system, and if the user is not yet registered with the system 10 to register at that time. The user may then choose to register an event, register a garment for an event, search for an event, search for a garment, read related articles, or post messages to the system 10. In one embodiment, the system 10 may be configured to include a plurality of screens with icons that may be actuated, such as by clicking a computer mouse, to enable a user to move through the variety of options presented by the system 10.

As shown in FIG. 2, the user may search for an event. If the event is found, the user may review the event. If an event is not found, the user may be directed to the event registration module 14 to register the event. The user may add the event to the garment registration system 10. Once added, a user may enter a dress with a particular event with the garment registration module 12 or browse existing garments registered with the garment registration system 10. The user may also review a message board on the event message module 24. The user may also conduct other searches as previously described.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A garment registration system, comprising:
a garment registration module configured to enable a garment to be registered in connection with an event and an event attendee;
wherein the registration module enables the event attendee to search the garment registration system to determine whether another event attendee is planning to wear a same garment to the event.

2. The garment registration system of claim 1, further comprising an event registration module that enables events to be registered to the system.

3. The garment registration system of claim 2, wherein the event registration module is selected from the group consisting of a community ball, a junior league ball, an inaugural ball, a philanthropic ball, a political fundraiser, a high school homecoming dance, a high school prom, a college greek function, a quinceanera party, a sweet sixteen party, and a new year's eve party.

4. The garment registration system of claim 1, further comprising an event search module enabling registered events to be searched.

5. The garment registration system of claim 4, wherein the event search module enables registered events to be searched by event location, event size, event date, event year, event name, type of event, event organizer, and event entertainment.

6. The garment registration system of claim 1, further comprising a user registration module enabling a person to register with the garment registration system.

7. The garment registration system of claim 1, further comprising a garment search module enabling a garment to be searched within the system.

8. The garment registration system of claim 7, wherein the garment search module enables a garment to be searched within the system by garment designer name, garment style, garment type, color, length, material, neckline, a description of the garment, and a UPC.

9. The garment registration system of claim 1, further comprising an event message module enabling messages to be posted for viewing.

10. The garment registration system of claim 9, wherein the event message module includes message boards selected from the group consisting of garments, types of events, and event locations.

11. The garment registration system of claim 1, further comprising an advertising module configured to enable advertisements to be viewed concurrently with display screens of the garment registration system.

12. A garment registration system, comprising:
a garment registration module configured to enable a garment to be registered in connection with an event and an event attendee;
an event registration module that enables events to be registered to the system;
an event search module enabling registered events to be searched;
a user registration module enabling a person to register with the garment registration system; and
a garment search module enabling a garment to be searched within the system to determine whether another event attendee is planning to wear a same garment to the event.

13. The garment registration system of claim 12, wherein the event registration module is selected from the group consisting of a community ball, a junior league ball, an inaugural ball, and a philanthropic ball, a political fundraiser, a high school homecoming dance, a high school prom, a college greek function, a quinceanera party, a sweet sixteen party, and a new year's eve party.

14. The garment registration system of claim 12, wherein the event search module enables registered events to be searched by event location, event size, event date, event year, event name, type of event, event organizer, and event entertainment.

15. The garment registration system of claim 12, wherein the garment search module enables a garment to be searched within the system by garment designer name, garment style, garment type, color, length, material, neckline, a description of the garment, and a UPC.

16. The garment registration system of claim 12, further comprising an event message module enabling messages to be posted for viewing.

17. The garment registration system of claim 16, wherein the event message module includes message boards selected from the group consisting of garments, types of events, and event locations.

18. The garment registration system of claim 12, further comprising an advertising module configured to enable advertisements to be viewed concurrently with display screens of the garment registration system.
